(19) United States
(12) Patent Application Publication
(10) Pub. No.: US 2015/0151149 A1
(43) Pub. Date: Jun. 4, 2015

(54) FIRE PREVENTION IN STORAGE SILOS

(71) Applicant: LINDE AKTIENGESELLSCHAFT, Munich (DE)

(72) Inventor: Ian Hibbitt, Hognaston (GB)

(21) Appl. No.: 14/418,297

(22) PCT Filed: Aug. 2, 2013
(86) PCT No.: PCT/EP13/66262

§ 371 Date: Jan. 29, 2015

(30) Foreign Application Priority Data
Aug. 2, 2012 (GB) 1213902.8

(51) Int. Cl. A62C 3/04; A62C 2/04; A62C 37/40

(52) U.S. Cl. CPC A62C 3/04; A62C 37/40; A62C 2/04

(57) ABSTRACT

In a silo for storing flammable materials, a plurality of gas inlet ports are provided in the silo for the introduction of a gas into the silo. A method of fire prevention within the storage silo introduces a fire retardant gas into the storage silo via the gas inlet ports, wherein only a portion of the gas inlet ports are in use at any one time.

The present invention relates to a method for preventing fires in silos for storing flammable materials. In particular, the invention relates to the prevention of fires in biomass storage silos.

The burning of biomass as a fuel in power stations has become more prevalent in recent years and the volume of biomass used and stored at power stations has correspondingly increased. In general terms, biomass comprises plant matter which is shredded and compacted into pellets. The pellets are stored in large silos prior to being conveyed for use in the boilers. Such silos can range from hundreds of cubic metres in volume to thousands of cubic metres. A typical source of biomass plant matter is wood and the following description is given in the context of wood biomass. However, the invention applies equally to other types of biomass and to other types of flammable materials.

Not only are biomass pellets stored in large silos, but so too is biomass dust which is generated from the pellets during storage and handling. The dust is drawn off in an air stream which is filtered to remove the dust. The dust is then pneumatically conveyed to dust silos where it is stored prior to being burnt in the boilers.

Fires may occur in both biomass pellet storage silos and dust storage silos, and the factors which cause fires in both cases are broadly the same. Fires in biomass storage silos can come about as a result of bacterial and fungal activity which generate heat and produce methane, carbon monoxide and carbon dioxide. Heat accumulates to over 50° C. leading to thermal oxidation of the wood. As the temperature continues to rise, dry matter is lost, fuel quality deteriorates and eventually the biomass ignites. The reactions are fed by water, oxygen and carbon dioxide.

Although water is the best medium for removing heat from smouldering fires, the use of water sprinklers would cause damage to the silos and cause wood dust to set, resulting in large costs and downtime. It is known in the art that smouldering fires can be controlled and extinguished by providing an inert atmosphere within the silo. This is commonly achieved by providing a carbon dioxide or nitrogen atmosphere within the silo.

The present invention provides a method of fire prevention within storage silos for storing flammable materials, the method comprising: providing a storage silo comprising a plurality of gas net ports; and introducing a fire retardant gas into the storage silo via the gas inlet ports, wherein the fire retardant gas is introduced into the storage silo in accordance with a gas injection protocol in which only a portion of the inlet ports are in use at any one time.

This method is advantageous as fire retardant gas can be introduced into the silo during use to prevent fires within the silo. By introducing gas through some, but not all, of the gas inlet ports, gas costs and wastage can be reduced.

Preferably the gas injection protocol is automatically controlled by a processor so that there is no need for manual intervention during operation. The processor is preferably re-programmable to allow different conditions within the silo to be accounted for. In a preferred embodiment, the processor is in communication with sensors within the silo to allow automatic control of the gases being introduced into the silo depending on the conditions within the silo, for example, normal operation (no fire event detected), fire event detected, escalated fire event detected, or critical fire event detected (see below).

The fire retardant gas preferably comprises nitrogen and more preferably comprises nitrogen of greater than or equal to 90% purity. Alternatively or additionally, the fire retardant gas may comprise carbon dioxide.

The gas inlet ports may be operated in a random sequence, but are more preferably operated in a predetermined sequence to ensure even distribution of the fire retardant gas during normal operation.

The method preferably further comprises: detecting a condition within the silo indicative of a fire event; determining the location of the fire event within the silo and using this information to define a treatment area; and introducing the fire retardant gas into the storage silo in accordance with a gas injection protocol in which substantially all of the fire retardant gas is introduced into the silo in the vicinity of the treatment area. This allows the fire retardant gas to be focussed in a problem area within the silo in the event that a fire is detected or in the event that conditions indicative of a fire starting are detected within the silo.

In a preferred embodiment, detecting a condition indicative of a fire event comprises detecting a change in carbon monoxide concentration. Sensing carbon monoxide is advantageous as an increased carbon monoxide concentration is a useful early indicator of a fire starting.

Detecting a condition indicative of a fire event may preferably also comprise, or further comprise, detecting heat. The detection of hot spots within the stored material pile is a useful early indicator of a fire starting.

In a further preferred embodiment the method comprises: detecting an escalated fire event within the storage silo; and introducing carbon dioxide into a headspace of the silo. The introduction of carbon dioxide in to the headspace of the silo covers the largest surface area of the material pile within the silo with a dense layer of carbon dioxide to suppress smoke and extinguish surface fires. The carbon dioxide also permeates through the pile by being drawn towards the fire at it consumes oxygen and creates a vacuum.

In one preferred embodiment, following detection of the escalated fire event, the fire retardant gas introduced into the silo via the gas injection ports substantially comprises carbon dioxide. Because the density of carbon dioxide is greater than nitrogen, once a fire event has been detected, it may be desirable to substantially stop or reduce any flow of nitrogen and introduce substantially only carbon dioxide into the silo via the gas injection ports.

As a last resort in the case of a critical fire event in which flames or significant quantities of smoke are detected, the method preferably further comprises: detecting a critical fire event within the storage silo; and introducing water into the silo. As mentioned above, water is the best medium for removing heat from fires, but water causes damage to the silos resulting in large costs and downtime.

An example of the invention will now be described with reference to the following drawings in which:

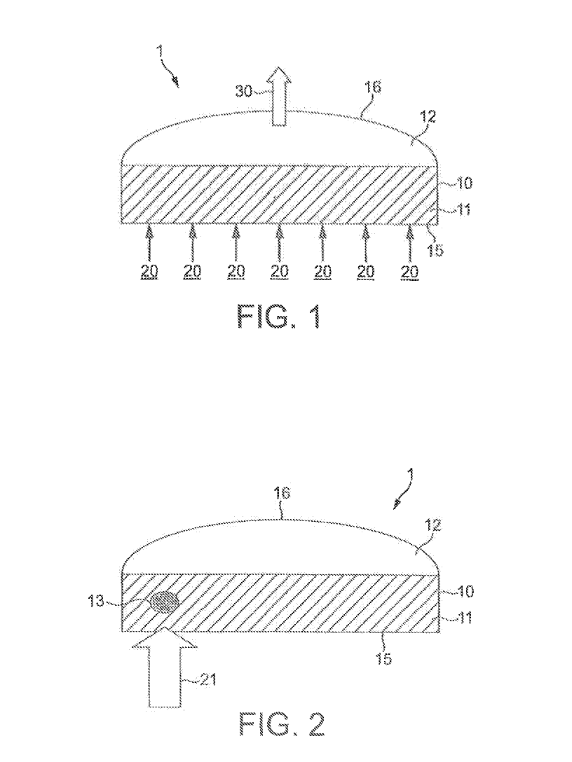

FIG. 1 shows a schematic diagram of a biomass storage silo;

FIG. 2 shows a schematic diagram of the silo of FIG. 1 in the case that a fire event has been detected;

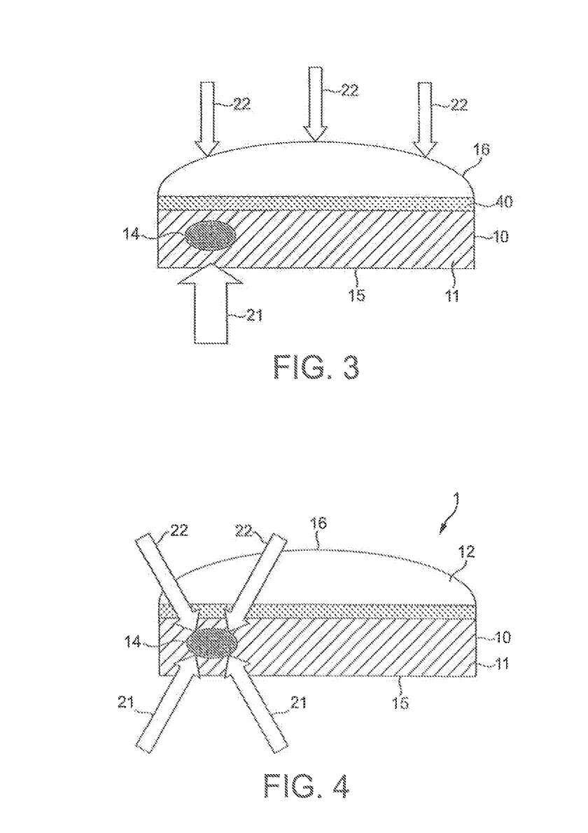

FIG. 3 shows a schematic diagram of the silo of FIG. 1 in the case that an escalated fire event has been detected; and

FIG. 4 shows a schematic diagram of the gas flows within the silo in the event that an escalated fire event has been detected.

As mentioned above, biomass storage silos can range from hundreds of cubic metres in volume to thousands of cubic metres in volume. In one example, a biomass storage silo 1 has a generally cylindrical shape comprising a substantially circular base 15, substantially vertical sidewalls 10 and a domed roof 16. In this example, the biomass silo 1 has a diameter of 60 m, a sidewall height of 20 m, and an overall height of 50 m. However, this is one example only and other size, shape or configuration of storage silo is contemplated depending on the needs of the particular locations and applications.

The silo 1 contains a pile of wood pellet biomass 11 (or other biomass) having an average diameter of 6 mm and an average length between 8 mm and 15 mm. The silo 1 is arranged for a first in first out usage system for the biomass pellets to reduce the residence time and thereby reduce the risk of the factors accumulating which cause fires (see above). Under normal use conditions, when there is no fire detected and no conditions detected which are indicative of a fire breaking out, nitrogen gas of between 90% and 99% purity is introduced into the base of the silo via gas inlet ports 20 which are spaced over the base 15 of the silo 1. The inlet ports 20 are generally evenly spaced in a grid pattern over the base 15. Some or all of the gas inlet ports 20 may optionally by covered by a protective housing (not shown) to prevent damage and blockages of the gas injection ports. The housing (if present) is made of a gas permeable material (including, but not limited to, a substantially solid/rigid material having sufficient holes to allow the fire retardant gas to pass through).

In order to maintain a sufficiently fire retardant atmosphere within the silo, whilst controlling the amount of nitrogen gas used, the introduction of the nitrogen gas into the silo is controlled so that only a portion of the gas inlet ports 20 are in use at any one time. This process is controlled by a processor (not shown) which is programmed according to the operating needs of the silo (for example, the fill level, time since last injection, amount of material being recovered and from where, and the age of the biomass in the silo). The processor may be re-programmable if desired. The processor may be programmed to operate the gas inlet ports 20 in sequence such that each set of ports operates for a selected period of time (for example, from 1 to 10 hours) and/or to deliver a selected amount of nitrogen gas into the silo before being shut off and the next set of gas inlet ports 20 in the sequence being activated. Alternatively, the processor may be programmed to activate the gas inlet ports 20 randomly.

The nitrogen gas introduced into the silo 1 rises up through the biomass pile 11 in accordance with the well know principals of fluid flow through packed beds. As the gas rises it collects reaction products such as water, methane, carbon dioxide and carbon monoxide which are generated in the biomass pile during storage (see above). The nitrogen and collected reaction products eventually reach the headspace 12 of the silo 1 and vent to atmosphere.

A plurality of carbon monoxide sensors (not shown) and heat sensors (not shown) are distributed throughout the storage space within the silo 1. Alternatively or additionally, a plurality of carbon monoxide sensors may be located above the stored material. The sensors may be located on supporting structures (not shown) located within the silo 1 if necessary. The sensors are in communication with the processor and feedback information relating to the conditions within the silo to the processor. In the event that heat and/or carbon monoxide are detected at levels indicative of a fire event 13 (that is to say a fire, or conditions which indicate that a fire is likely to start) the processor is programmed to activate only those gas inlet ports 20 in the region of the base 15 below the fire event 13. This is illustrated in FIG. 2 by nitrogen gas flow 21. By focussing the flow of nitrogen gas entering the silo in the region below the fire event, the fire suppressing nitrogen gas is concentrated in the problem area helping to more effectively and efficiently suppress the fire event. The oxygen concentration is greatly reduced and there is also some cooling associated with the focussed flow of nitrogen gas 21.

Should the fire event not be controlled by the focussed flow of nitrogen gas 21, an escalated fire event 14 may develop within the silo 1. In this situation a flow of carbon dioxide 22 is directed (by the processor or by manual activation) into the headspace of the silo via carbon dioxide inlet ports (not shown). This has the effect of creating a dense blanket of carbon dioxide over the largest surface area of the biomass pile to suppress smoke and extinguish surface fires. In addition, as illustrated in FIG. 4, the carbon dioxide flow 22 and nitrogen flow 21 are drawn towards the escalated fire event 14 by the vacuum created as the fire consumes the local oxygen supply.

The carbon dioxide gas introduced into the headspace of the silo may be introduced in gaseous form or liquid form. In the case that liquid carbon dioxide is used, the carbon dioxide flashes to solid on entry to the headspace and then sublimes to gas.

In some instances it may be desirable to replace the nitrogen flow through the gas inlet ports 20 with carbon dioxide when a fire event has been detected. In this case, carbon dioxide is introduced into the base of the silo via the gas injection ports 20 and into the headspace. Carbon dioxide has greater density and heat capacity than nitrogen and is therefore able to form a more substantially stable fire retardant cover. However, carbon dioxide is more expensive and not as readily available as nitrogen. It is therefore preferable to use nitrogen in normal operating conditions, and only switch to carbon dioxide once a fire event, or escalated fire event, has been detected.

As a last resort, should the escalated fire event 14 not be extinguished, the biomass pile can be deluged with water. However, this is undesirable as water deluge causes damage to the silos and causes wood dust to set and pellets to expand substantially causing damage to the silo and resulting in large costs and downtime.

The supply of nitrogen gas to the gas inlet ports 20 may be provided from a liquid nitrogen gas store, a Pressure Swing Adsorption (PSA) unit, a membrane filter unit, or any other suitable source. The purity of nitrogen available from a membrane filter unit is less than that available from either a liquid nitrogen source or a PSA unit, however, it is possible for a membrane filter unit to supply nitrogen gas at 90 to 99% purity as required for the operation of the system. In another example, one of more of these nitrogen gas sources may be provided. For example a liquid nitrogen store may be provided as a back up.

The carbon dioxide is typically supplied from a liquid carbon dioxide store.

Although a flat based silo 1 is described herein, it will be clear to a person skilled in the art that the silo may be of any suitable configuration. For example, the base may be concave with gas inlet ports 20 located over the entire base, including non horizontal surfaces.

1. A method of fire prevention within storage silos for storing flammable materials, the method comprising:
providing a storage silo having a plurality of gas inlet ports; and
introducing a fire retardant gas into the storage silo via the gas inlet ports, wherein the fire retardant gas is introduced into the storage silo in accordance with a gas injection protocol in which only a portion of the inlet ports are in use at any one time.

2. A method as claimed in claim 1, wherein the gas injection protocol is automatically controlled by a processor,

3. A method as claimed in claim 1, wherein the fire retardant gas comprises nitrogen or carbon dioxide.

4. A method as claimed in claim 1, wherein the gas inlet ports are operated in a predetermined sequence.

5. A method as claimed in claim 1, wherein the gas inlet ports are operated in a random sequence.

6. A method as claimed in claim 1, further comprising:
detecting a condition within the silo indicative of a fire event;
determining the location of the fire event within the silo and using this information to define a treatment area; and
introducing the fire retardant gas into the storage silo in accordance with a gas injection protocol in which substantially all of the fire retardant gas is introduced into the silo in the vicinity of the treatment area.

7. A method as claimed in claim 6, wherein detecting a condition indicative of a fire event comprises detecting a change in carbon monoxide concentration.

8. A method as claimed in claim 6, wherein detecting a condition indicative of a fire event comprises detecting heat.

9. A method as claimed in claim 1 further comprising:
detecting an escalated fire event within the storage silo; and
introducing carbon dioxide into a headspace of the silo.

10. A method as claimed in claim 9 wherein, following detection of the escalated fire event, the fire retardant gas introduced into the silo via the gas injection ports substantially comprises carbon dioxide.

11. A method as claimed in claim 1 further comprising:
detecting a critical fire event within the storage silo; and
introducing water into the silo.
